(19) United States
(12) Patent Application Publication
(10) Pub. No.: US 2011/0116266 A1
(43) Pub. Date: May 19, 2011

(54) LED BULB WITH MODULES HAVING SIDE-EMITTING LIGHT EMITTING DIODES AND ROTATABLE BASE

(75) Inventor: Steven Kim, Riverdale, NJ (US)

(73) Assignee: LED FOLIO CORPORATION, Riverdale, NJ (US)

(21) Appl. No.: 12/619,041

(22) Filed: Nov. 16, 2009

(51) Int. Cl. F21S 4/00

(52) U.S. Cl. 362/249.02; 313/318.01

(57) ABSTRACT

Disclosed is a light emitting diode bulb having a base member having a first surface and a second surface, an electrical connector at the first surface of the base member, a plurality of light emitting diode modules stacked on the second surface and along an axis line, a region defined by two radii extending from the axis and an outer periphery of the plurality of light emitting diodes modules, and a plurality of side-emitting light emitting diodes on each of the plurality of light emitting diode modules wherein the plurality of side-emitting light emitting diodes is within the region.

### BACKGROUND OF THE INVENTION

1. Field of the Invention

The embodiments of the invention relate to a light emitting diode (hereinafter “LED”) bulb, and more particularly, to a LED bulb with modules having side-emitting LEDs. Although embodiments of the invention are suitable for a wide scope of applications, they are particularly suitable for lighting applications that can otherwise use compact fluorescent bulbs or incandescent bulbs.

2. Discussion of the Related Art

In general, the LED bulb is more energy efficient than either an incandescent bulb or a compact fluorescent bulb. An incandescent bulb converts about 3% of the supplied power into light at about 14-16 lumens/watt. A compact fluorescent bulb converts about 12% of the supplied power into light at about 60-72 lumens/watt. An LED bulb converts about 18% of the supplied power into light at about 93-95 lumens/watt. The rest of the supplied power for each of the incandescent bulb, the compact fluorescent bulb and the LED bulb is usually expended as heat.

An incandescent bulb uses a filament to create light. A compact fluorescent bulb uses a gas excited by an electric field to create light. An LED bulb uses one or more LEDs in which each of the LEDs uses a semiconductor chip to create light. Because the LED bulb uses a semiconductor chip, the LED bulb can have a much longer life term than either an incandescent bulb or a compact fluorescent bulb.

The light produced by traditional incandescent and florescent bulbs is largely omni-directional. Light emerges from the light source and radiates in all directions. However, in some applications, it is unnecessary to have light radiating in such a manner. Often illumination is only needed in a particular area or a single direction. For example, the purpose of a recessed ceiling light fixture is to radiate light downwards on to the objects below the fixture. There is no need to have light projected up and into the ceiling fixture. However, due to the nature of traditional bulbs, light is none the less radiated omni-directionally. Some of the energy used to create the light is wasted by unnecessarily illuminating unintended areas.

Many lighting fixtures utilizing traditional bulbs are designed with reflectors which reflect light radiating in the wrong direction in a direction toward the intended area. While reflectors increase the amount of usable light from a fixture, such designs are not completely efficient and some of the light energy is lost. Additionally, because reflectors must surround the bulb, cooling of the fixture can be inhibited so as to shorten the life of the bulb.

Incandescent bulbs come in different light output capabilities, different shapes, different sizes and different types of electrical connections. Although a compact fluorescent bulb is a completely different light technology than the incandescent bulb, compact fluorescent bulbs have been manufactured to have many of the same light output capacities as well as the same size, shape and screw-in type electrical connections as incandescent bulbs. Attempts have been made to achieve the same with LED bulbs but the need for heatsinks has made such previously attempted LED bulbs unsightly or unworkable.

### SUMMARY OF THE INVENTION

Accordingly, embodiments of the invention are directed to an LED bulb with modules having side-emitting LEDs that substantially obviates one or more of the problems due to limitations and disadvantages of the related art.

An object of embodiments of the invention is to provide an LED bulb that only radiates light throughout a particular angular range.

Another object of embodiments of the invention is to provide an LED bulb with a light source that rotates on the base that connects to a light fixture.

Another object of embodiments of the invention is to provide the number of LEDs required to achieve illumination comparable with incandescent and florescent bulbs for a predetermined area.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a light emitting diode bulb includes: a base member having a first surface and a second surface, an electrical connector at the first surface of the base member, a plurality of light emitting diode modules stacked on the second surface and along an axis line, a region defined by two radii extending from the axis and an outer periphery of the plurality of light emitting diodes modules, and a plurality of side-emitting light emitting diodes on each of the plurality of light emitting diode modules wherein the plurality of side-emitting light emitting diodes is within the region.

In another aspect, the light emitting diode bulb includes: a base member having a first surface and a second surface, an electrical connector at the first surface of the base member, a pillar rotatably connected to the second surface of the base member, a plurality of light emitting diode modules stacked on the pillar, and a plurality of side-emitting light emitting diodes on each of the plurality of light emitting diode modules.

In yet another aspect, a light emitting diode bulb includes: a base member having a first surface and a second surface, an electrical connector at the first surface of the base member, a pillar rotatably connected to the second surface of the base member, a plurality of light emitting diode modules connected to the pillar, a region defined by two radii extending from the pillar and an outer periphery of the plurality of light emitting diodes, and a plurality of side-emitting light emitting diodes on each of the plurality of light emitting diode modules wherein the plurality of side-emitting light emitting diodes exist in the region.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an assembly view of an LED bulb according to a first exemplary embodiment of the invention;

FIG. 2a is a top view of an LED module according to an embodiment of the invention;

FIG. 2b is a side view of the LED module in FIG. 2a;

FIG. 2c is an assembly view of the LED module in FIG. 2b;

FIG. 3a is a top view of a circuit board with parallel connected LEDs;

FIG. 3b is a bottom view of a circuit board with parallel connected LEDs;

FIG. 4 is a top view of an LED module having a 90° arc;

FIG. 5 is a top view of an LED module having a 270° arc;

FIG. 6 is a top view of an LED module having two 90° arcs;

FIG. 7 is a cross-sectional view of the LED bulb of FIG. 1 showing air flow;

FIG. 8 is an isometric view of an LED bulb according to another exemplary embodiment of the invention;

FIG. 9 is an isometric view of an LED bulb according to another exemplary embodiment of the invention;

FIG. 10 is a side view of an LED bulb according to an exemplary embodiment of the invention in an exemplary environment; and

FIG. 11 is a side view of an LED bulb according to an exemplary embodiment of the invention in an exemplary environment.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

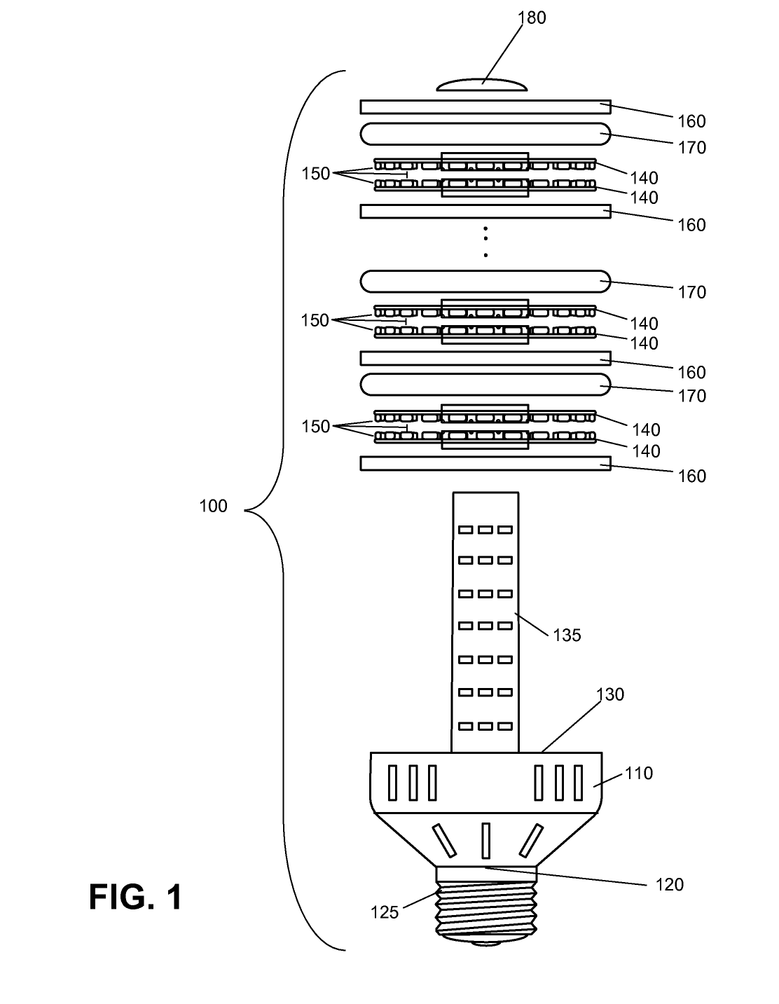

FIG. 1 is an assembly view of an LED bulb according to an exemplary embodiment of the invention. As shown in FIG. 1, an LED bulb 100 has a base 110 with a first surface 120 and a second surface 130. An electrical connector 125 is located on the first surface 120. A plurality of LED modules 140 are stacked on the second surface 130. Each of the LED modules 140 is populated with a plurality of side-emitting LEDs 150. Heat sinks 160 are used to facilitate heat transfer from LED modules and maintain spacing between the LED module. Light diffusers 170 cover the LED modules 140 to diffuse the light from the plurality of LEDs 150. More specifically, each of the light diffusers 170 surrounds a pair of the plurality of side-emitting LEDs 150. In this embodiment, a pillar 135 is attached to the second surface 130. The pillar 135 can serve as an attachment point and stabilization structure for the plurality LED modules 140. The pillar 135 can also serve as a chimney for heat generated by the LED bulb 100 by removing heat from the heat sinks through the wall of the pillar 135. A cap 180 secures the LED modules, diffusers, and heat sinks onto the pillar 135. The assembled LED bulb 100 can be somewhat similar in size and shape to a typical incandescent bulb or a typical compact fluorescent bulb.

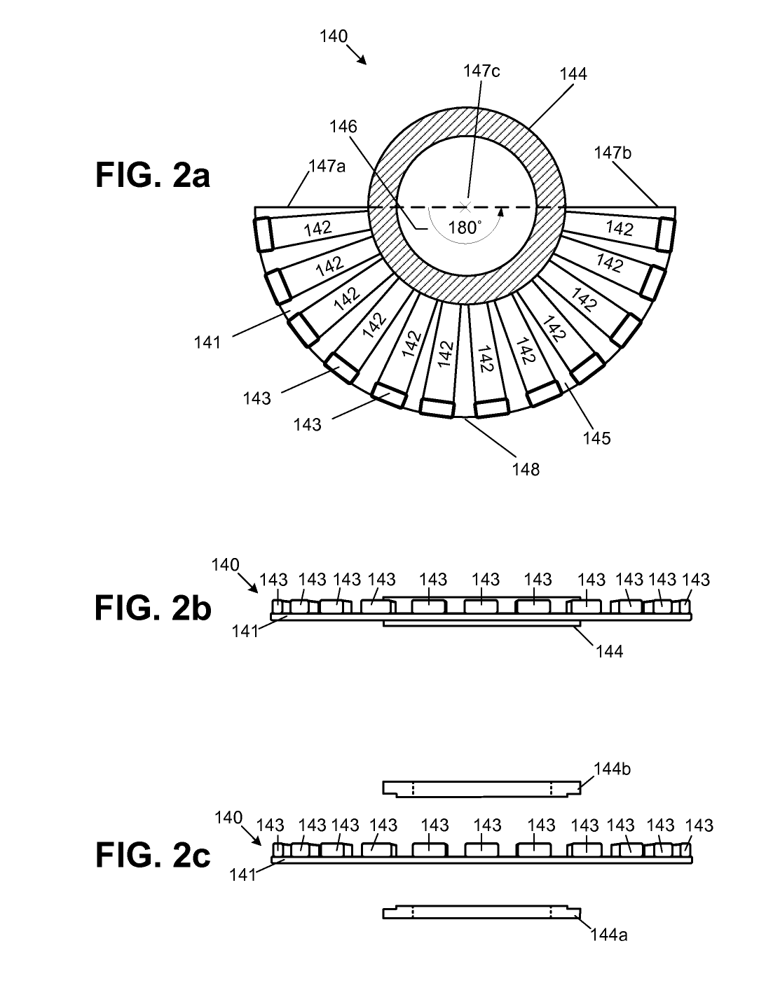

FIG. 2a is a top view of an LED module having a 180° arc and FIG. 2b is a side view of the same. As shown in FIG. 2a, an LED module 140 includes a circuit board 141 with electrical traces 142, side-emitting LEDs 143 mounted on the circuit board at one end of the electrical traces 142, and interboard connector 144 at the other end of the electrical traces 142.

The side-emitting LEDs 143 are provided in a region 145 of the LED module 140 bounded by a periphery 145 of the LED module and two radii 147a and 147b of the LED module. The side-emitting LEDs 143 can be oriented substantially radially such that the light emitted projects outwards from the center point 147c between the two radii 147a and 147b. The side-emitting LEDs 143 can be arranged on a periphery 148 of the LED module 140. The side-emitting LEDs 143 can be arranged on a curve so as to have an arc 146. The angle of the arc 146 shown in FIG. 2a measures 180°.

Embodiments of the invention are not limited to arcs of 180°. For example, arcs of 90° and 270° are also contemplated as well as embodiments having multiple arcs.

An LED module according to the above disclosed embodiment specifically provides light radiation to predefined areas. An LED module having side-emitting LEDs in a 180° arc radiates light in substantially a 180° field. Other areas beyond such a 180° field are not illuminated by the LED bulb. Selective illumination affords users of LED light bulbs lighting options and configurations not available with traditional omni-directional bulbs. Additionally, energy is saved and operating heat is reduced by only illuminating in a predefined direction.

Heat generated by the side-emitting LEDs 143 can be transferred through the electrical traces 142 to the interboard connector 144. Further, heat being transferred into the electrical traces 142 from the side-emitting LEDs can be radiated into the air by the electrical traces 142. Furthermore, heat from the electrical traces 142 can be transferred into the heatsinks 160 through the circuit board 141.

The side-emitting LEDs 143 are electrically connected to the electrical traces 142. The interboard connector 144 has conductors (not shown) that connect to the electrical traces 142 and run to the upper and lower surfaces of the interboard connector 144 such that direct current voltage can be supplied to the side-emitting LEDs 143 of an LED module 140 from an adjoining interboard connector or a power converter (not shown). Thus, the conductors (not shown) of the interboard connector 144 are configured such that a plurality of LED modules can be stacked upon each other and adjoining interboard connectors will provide direct current voltage to all of the side-emitting LEDs 143 in the stack of LED modules 140.

As shown in FIG. 2b, the interboard connector 144 extends above and below the circuit board 141 of the LED module 140. Upon stacking a plurality of LED modules 140, only the interboard connector 144 of each LED module 140 contacts the interboard connector 144 of another LED module 140. Thus, the interboard connector 144 provides a spacing or gap between the circuit boards 141 and the side-emitting LEDs 143 of adjacent LED modules.

FIG. 2c is an assembly view of the LED module shown in FIG. 2b. As shown in FIG. 2c, an interboard connector 144 can have a lower portion 144a and a top portion 144b that are joined together onto the electrical traces 142 of the circuit board 141. By assembling the lower and upper portions 144a and 144b of the interboard connector 144 onto the circuit board 141, the interboard connector 144 can provide spacing between LED modules 140, power to the side-emitting LEDs 143 of the modules 140 through the electrical traces 142 and receive heat from the side-emitting LEDs 143 through the electrical traces 142.

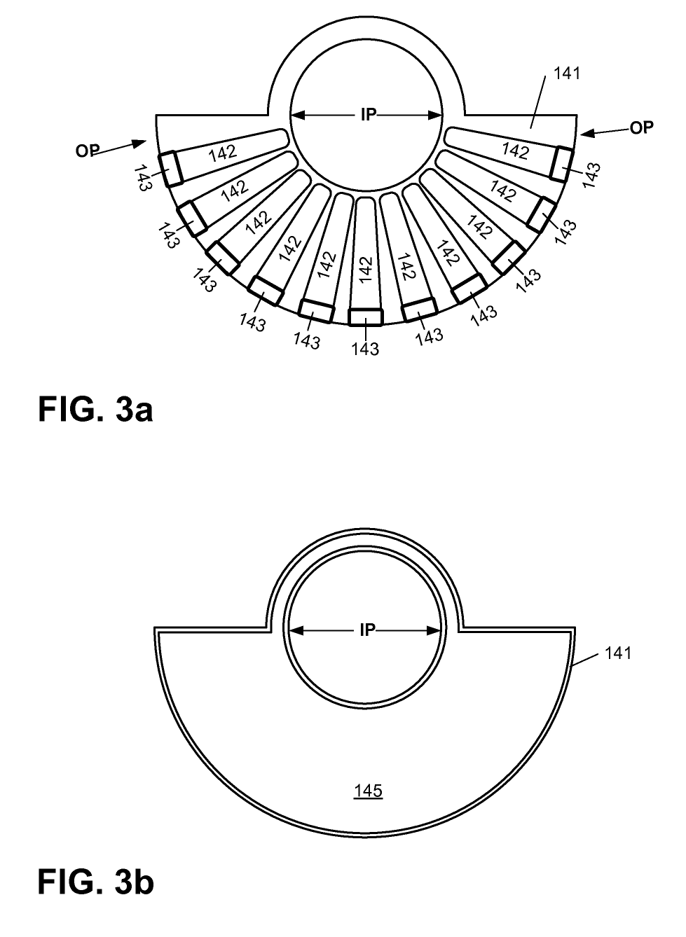

FIG. 3a is a top view of a circuit board with parallel connected LEDs and FIG. 3b is a bottom view of a circuit board with parallel connected LEDs. As shown in FIG. 3a, a circuit board 141 has an inner periphery IP and an outer periphery OP. Electrical traces 142 on the circuit board 141 have a radial pattern running from the inner periphery IP to the outer periphery OP of the circuit board 141. The electrical traces 142 are relatively wide such that heat from the side-emitting LEDs 143 transferred into the electrical traces 142 can be radiated into the air. As shown in FIG. 3b, a backplane electrode 145 covers most of the side of the circuit board 141 opposite to the side having the radial electrical traces 142.

The LEDs 143 at the outer periphery of the circuit board 141 are side-emitting LEDs in that light generally emanates from the side-emitting LEDs 143 in the same radial direction as the electrical trace on which an LED is mounted. The light of the side-emitting LEDs 143 is directed outward away from the circuit board 141 such that light is not directed at another circuit board when modules including the circuit boards are stacked, as shown in FIG. 1. By using side-emitting LEDs 143, which generally emit light in radial direction away from the circuit board 141, light efficiency is improved since all light is generally emitted in direction away from the infrastructure of the LED bulb 100 when modules including the circuit boards 141 are stacked, as shown in FIG. 1.

The side-emitting LEDs 143 are two terminal devices in which one terminal of each of the side-emitting LEDs 143 is connected one of the electrical traces 142. The other terminal of each of the side-emitting LEDs 143 is connected to the backplane electrode 145 on the other side of the circuit board 141, as shown in FIG. 3a. Because the side-emitting LEDs 143 are respectively connected to the electrical traces 142 and commonly connected to the backplane electrode 145, the side-emitting LEDs 143 can be supplied direct current voltage in parallel to each other. An electrical failure in one LED on the circuit board 141 of parallel connected LEDs will not effect the operation of the other LEDs on the circuit board 141.

The electrical traces 142 and the backplane electrode 145 are formed of a metal or a metal alloy, such as aluminum or a copper alloy. The metal or metal alloy dissipates heat from the side-emitting LEDs 143 and transfers heat from the side-emitting LEDs 143 to the interboard connector 144. Although the backplane electrode 145 does not directly receive heat transfer from the side-emitting LEDs 143, the backplane electrode 145 can absorb heat through the circuit board 141 and radiate that heat into the heatsink.

Heatsinks can be made from a material that is not electrically conductive to prevent electrical continuity between adjacent LED modules through the heatsink. Alternatively, a heatsink can be made from an electrically conductive material such as copper, aluminum, or steel that is then sheathed in a thin layer of thermally conductive but not electrically conductive material as mica or aluminum nitride. Heatsinks can conduct heat from the LED modules by direct contact with the LED modules. Alternatively, heatsinks and LED modules can be joined using thermal paste to increase the thermally conductive surface area. Thermal paste can contain thermally conductive ceramic compounds such as beryllium oxide, aluminium nitride, aluminum oxide, zinc oxide, or silicon dioxide. Thermal paste can also contain thermally conductive metal or carbon compounds such as silver, aluminum, liquid gallium, diamond powder, or carbon fibers. The thermal paste can use silicone as a medium to suspend the thermally conductive materials.

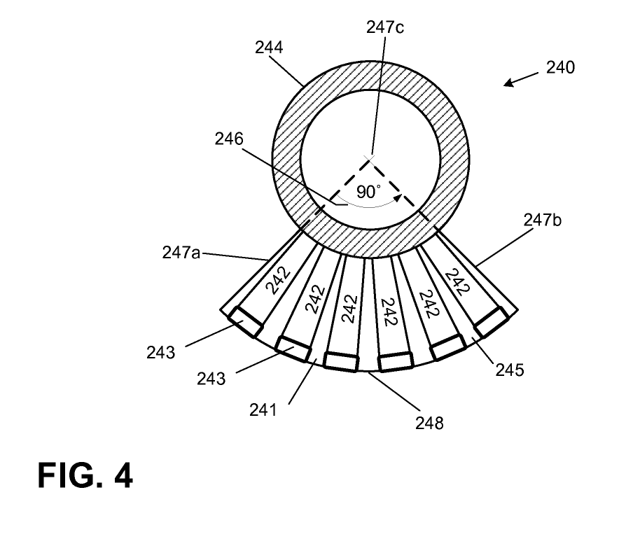

FIG. 4 is a top view of an LED module having a 90° arc and As shown in FIG. 4, a LED module 240 includes a circuit board 241 with electrical traces 242, side-emitting LEDs 243 mounted on the circuit board at one end of the electrical traces 242, and interboard connector 244 at the other end of the electrical traces 242.

The side-emitting LEDs 243 are provided in a region 245 of the LED module 240 bounded by a peripheral 245 of the LED module and two radii 247a and 247b of the LED module. The side-emitting LEDs 243 can be oriented substantially radially such that the light emitted projects outwards from the center point 247c between the two radii 247a and 247b. The side-emitting LEDs 243 can be arranged on a periphery 248 of the LED module 240. The side-emitting LEDs 243 can be arranged on a curve so as to have an arc 246. The angle of the arc 246 shown in FIG. 4 measures 90°.

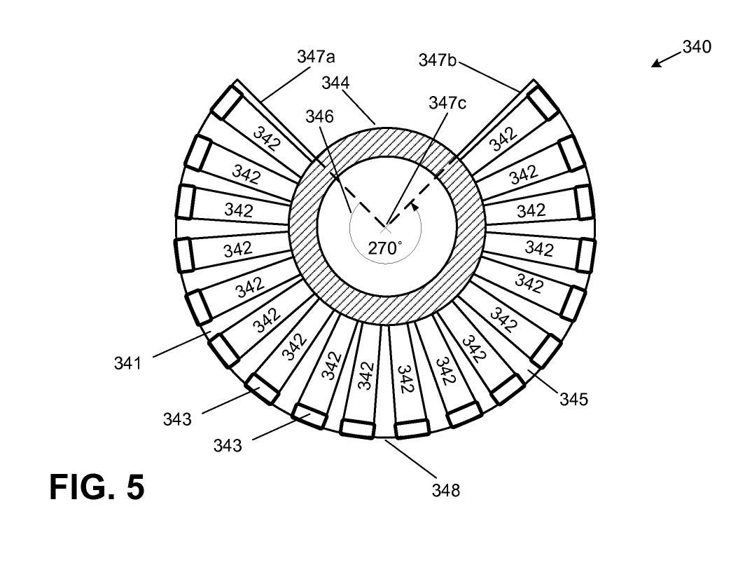

FIG. 5 is a top view of an LED module having a 270° arc. As shown in FIG. 5, a LED module 340 includes a circuit board 341 with electrical traces 342, side-emitting LEDs 343 mounted on the circuit board at one end of the electrical traces 342, and interboard connector 344 at the other end of the electrical traces 342.

The side-emitting LEDs 343 are provided in a region 345 of the LED module 340 bounded by a peripheral 345 of the LED module and two radii 347a and 347b of the LED module. The side-emitting LEDs 343 can be oriented substantially radially such that the light emitted projects outwards from the center point 347c between the two radii 347a and 347b. The side-emitting LEDs 343 can be arranged on a periphery 348 of the LED module 340. The side-emitting LEDs 343 can be arranged on a curve so as to have an arc 346. The angle of the arc 346 shown in FIG. 5 measures 270°.

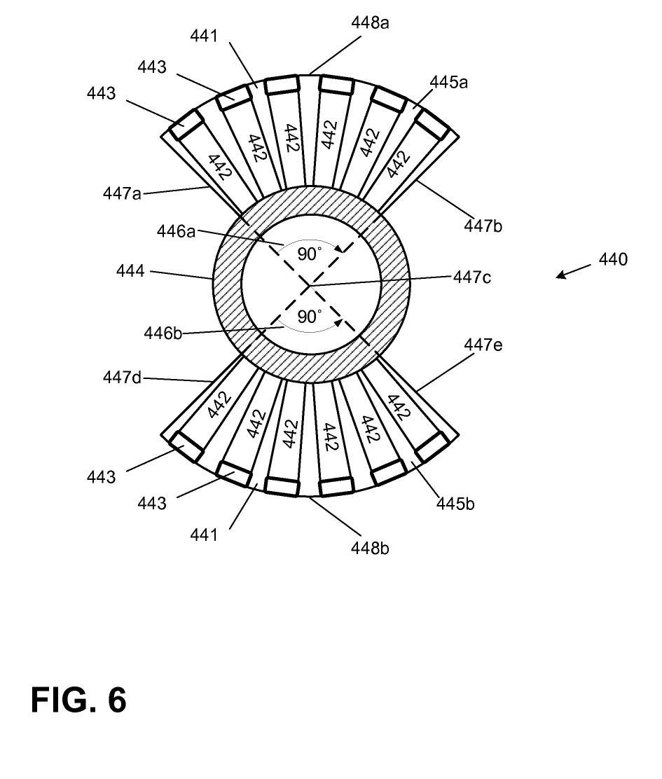

FIG. 6 is a top view of an LED module having two 90° arcs. As shown in FIG. 6, an LED module 440 includes a circuit board 441 with electrical traces 442, side-emitting LEDs 443 mounted on the circuit board at one end of the electrical traces 442, and interboard connector 444 at the other end of the electrical traces 442.

The side-emitting LEDs 443 exist in two regions 445a and 445b of the LED module. Region 145a is bounded by the periphery 448a of the LED module 440 and two radii 447a and 447b of the LED module 440. Region 445b has an arc 446b between the two radii 447d and 447e. The side-emitting LEDs 443 can be oriented substantially radially such that the light emitted projects outwards from the center point 447c between the two radii 447a and 447b and between the two radii 447d and 447e. The side-emitting LEDs 443 can be arranged on a periphery 448a/448b of the LED module 440. The side-emitting LEDs 443 can be arranged on a curve so as to have an arc 446a/446b. Each of the two arcs 446a and 446b shown in FIG. 6 have and angle measuring 90° and are offset by from each other 90°.

The configuration of the LED module shown in FIG. 5 is useful for illuminating two discrete areas using a single LED bulb and electrical connector such as illuminating towards both ends of a hallway using an existing light fixture in the middle of the hallway. While such a configuration has been shown and described, LED light modules with multiple arcs of varying sizes and varying offsets can also be implemented.

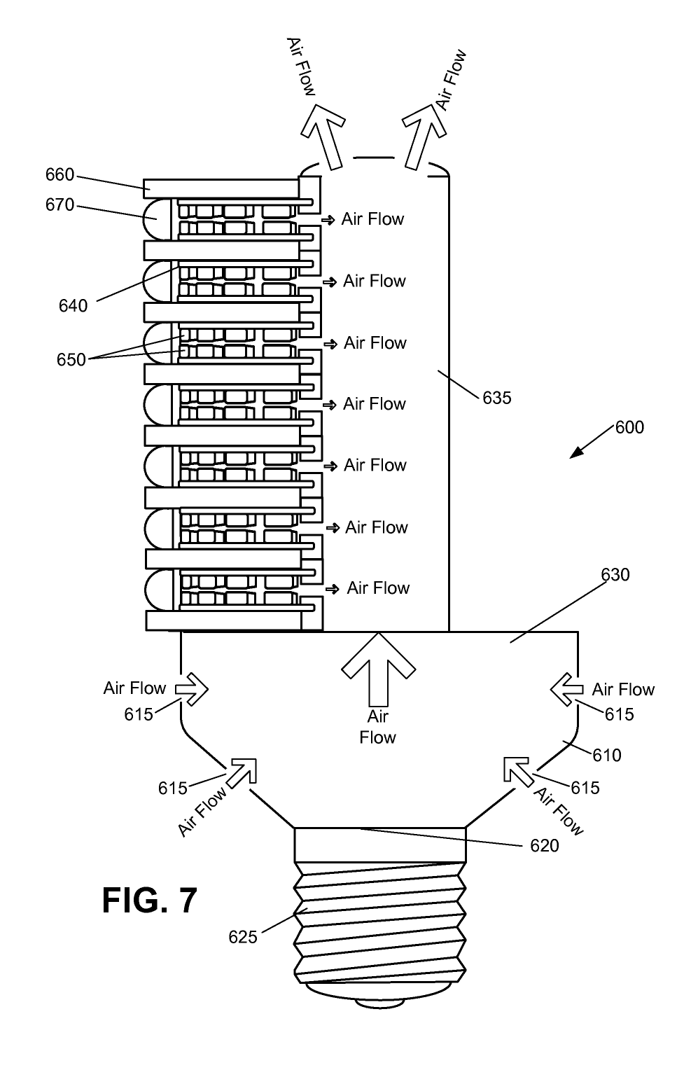

FIG. 7 is a cross-sectional view of an LED bulb according to the first exemplary embodiment of the invention. As shown in FIG. 7, an LED bulb 600 has a base 610 with a first surface 620 and a second surface 630. An electrical connector 625 is located on the first surface 620. A plurality of LED modules 640 are stacked on the second surface 630. Each of the LED modules 640 is populated with a plurality of side-emitting LEDs 650. Heat sinks 660 are used to facilitate heat transfer from LED modules and maintain spacing between the LED modules. Light diffusers 670 cover the LED modules 640 to diffuse the light from the plurality of LEDs 650. More specifically, each of the light diffusers 670 surrounds a pair of the plurality of LEDs modules 640. In this embodiment, a pillar 635 is attached to the second surface 630. The pillar 635 serves as an attachment and stabilization structure for the plurality LED modules 640. The pillar 635 can also serve as a chimney for heat generated by the LED bulb 600 by removing heat from the heatsinks though the wall of the pillar 635. The electrical connector 625 can be a screw-in type electrical connector such as an Edison E27 screw-in type connector. The base 610 has openings 615 in the sides of the base 610 between the pillar 635 and the electrical connector 625.

The diffuser 670 can be either translucent or transparent. For example, a translucent diffuser can have a diffusion coating on the inside surface and/or outside surface of the cover to diffuse the light emitted from the side-emitting LEDs of the LED modules 640. In another example, a translucent cover can have a phosphor coating on the inside surface and/or outside surface of the cover to convert ultraviolet light emitted from the side-emitting LEDs of the LED modules 640 into visible light.

As shown in FIG. 7, all of the LED modules 640 in the first exemplary embodiment have the same diameter and the same number of side-emitting LEDs on each of the LED modules 640. However, embodiments of the invention can contain a plurality of modules in which at least some the LED modules have different diameters and a different number of side-emitting LEDs. For example, an LED bulb may first have six modules that are about three inches wide with twenty-four side-emitting LEDs and modules with successively decreasing numbers of side-emitting LEDs and successively decreasing diameters down to an LED module that is about one inch wide with six side-emitting LEDs.

FIG. 7 also shows air flow in an exemplary embodiment of the invention. As shown in FIG. 7, the openings 615 in the base 610 allow air movement through the base 610 and through the pillar 635 such that the LED modules 640 can be cooled. Although the air flow is shown going through the base 610 and then into the LED module area of the LED bulb 600 shown in FIG. 7, the air flow would be reversed if the LED bulb 600 is implemented upside down due to the convection current nature of heated air.

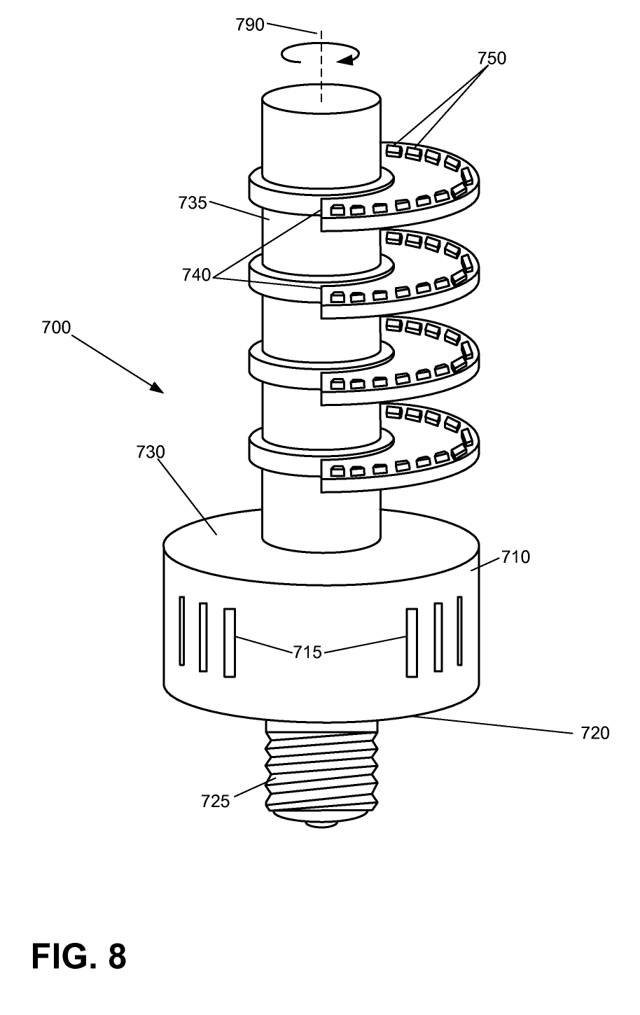

FIG. 8 shows an isometric view of an LED bulb according to an embodiment of the invention. As shown in FIG. 8, an LED bulb 700 has a base 710 with a first surface 720 and a second surface 730. An electrical connector 725 is located on the first surface 720. A plurality of LED modules 740 are stacked on the second surface 730. Each of the LED modules 740 is populated with a plurality of side-emitting LEDs 750. Heat sinks (not shown) and diffusers (not shown) have been omitted for clarity. In this embodiment, a pillar 735 is attached to the second surface 730. The pillar 735 serves as an attachment and stabilization structure for the plurality LED modules 740. The pillar 735 can also serve as a chimney for heat generated by the LED bulb 700 by removing heat from the heatsinks through the wall of the pillar 735. The electrical connector 725 can be a screw-in type electrical connector, such as an Edison E27 screw-in type connector. The base 710 has openings 715 in the sides of the base 710 between the pillar 735 and the electrical connector 725.

When the LED bulb is connected to an electrical appliance via the electrical connector 725, the position of the LED modules 740 is often dictated by the geometry of the electrical connector 725 and the socket to which it connects. Because the LED bulb in this embodiment is a directional light source, repositioning of the LED modules is desirable. Thus, in an exemplary embodiment of the invention, the pillar 735 can be rotatably connected to the second surface 730 of the base 710. The pillar 735 can rotate in a plane substantially parallel to the second surface 730 by rotating on an axis 790 that is substantially perpendicular to the second surface 730 as shown in FIG. 8. This rotating embodiment facilitates adjustment of the LED modules 740 after the LED bulb 700 has been installed.

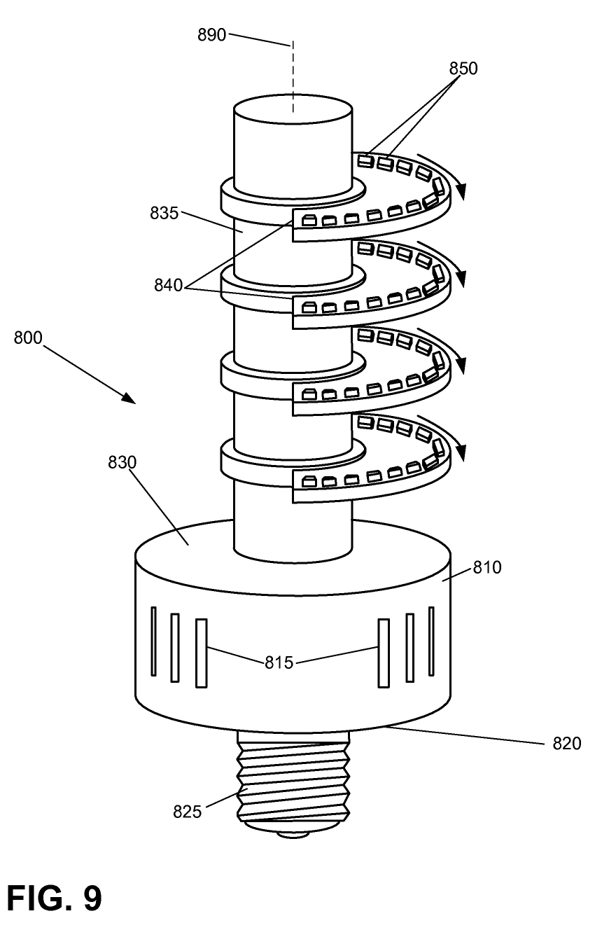

FIG. 9 shows an isometric view of an LED bulb according to an embodiment of the invention. As shown in FIG. 9, an LED bulb 800 has a base 810 with a first surface 820 and a second surface 830. An electrical connector 825 is located on the first surface 820. A plurality of LED modules 840 are stacked on the second surface 830. Each of the LED modules 840 is populated with a plurality of side-emitting LEDs 850. Heat sinks (not shown) and diffusers (not shown) have been omitted for clarity. In this embodiment, a pillar 835 is attached to the second surface 830. The pillar 835 serves as an attachment and stabilization structure for the plurality LED modules 840. The pillar 835 can also serve as a chimney for heat generated by the LED bulb 800 by removing heat from the heatsinks through the wall of the pillar 835. The electrical connector 825 can be a screw-in type electrical connector, such as an Edison E27 screw-in type connector. The base 810 has openings 815 in the sides of the base 810 between the pillar 835 and the electrical connector 825.

When the LED bulb is connected to an electrical appliance via the electrical connector 825, the position of the LED modules 840 is often dictated by the geometry of the electrical connector 825 and the socket to which it connects. Because the LED bulb in this embodiment is a directional light source, repositioning of the LED modules is desirable. Thus, in an exemplary embodiment of the invention, the LED modules 840 can be rotatably connected to the pillar 835. The LED modules 840 can rotate in a plane substantially parallel to the second surface 830 by rotating on an axis 890 that is substantially perpendicular to the second surface 830 as shown in FIG. 9. This rotating embodiment facilitates adjustment of the LED modules 840 after the LED bulb 800 has been installed.

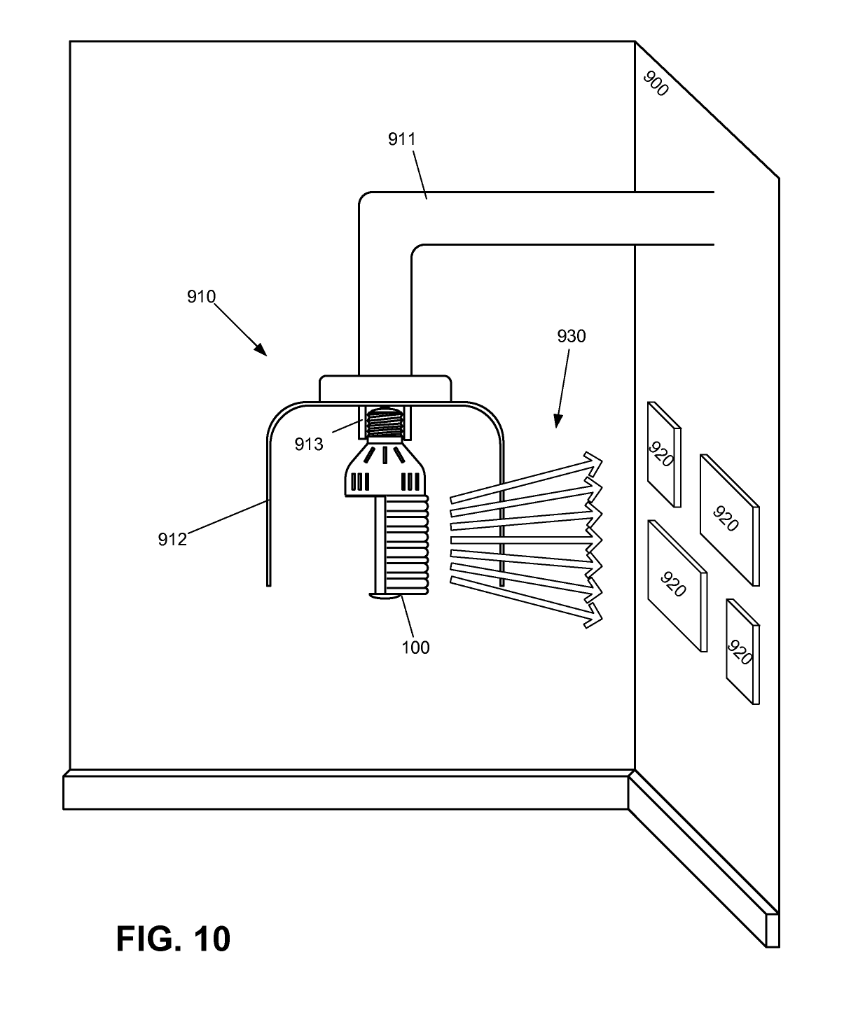

FIG. 10. shows an exemplary application of an LED bulb according to an embodiment of the invention. As shown in FIG. 10, The environment includes a wall 900, a wall-mounted light fixture 910 (enlarged to show detail), and objects 920 attached to the wall 900. The light fixture 910 includes a mounting arm 911, a shade 912, and an electrical socket 913. An LED bulb 100 according to an embodiment of the invention is connected to the electrical socket 913 of the light fixture 910. Exemplary light rays 930 illustrating light radiating from the LED bulb 900 illuminate the objects 920 attached to the wall 900. The objects 920 attached to the wall 900 can be pictures, paintings or other decorative furnishings.

In such an environment, it can be desirable to illuminate only the objects 920 and minimize light emanated into other areas of the environment. An LED bulb according to an embodiment of the invention can be utilized to efficiently achieve the desired lighting effect. No light is wasted by needlessly illuminating other areas of the environment.

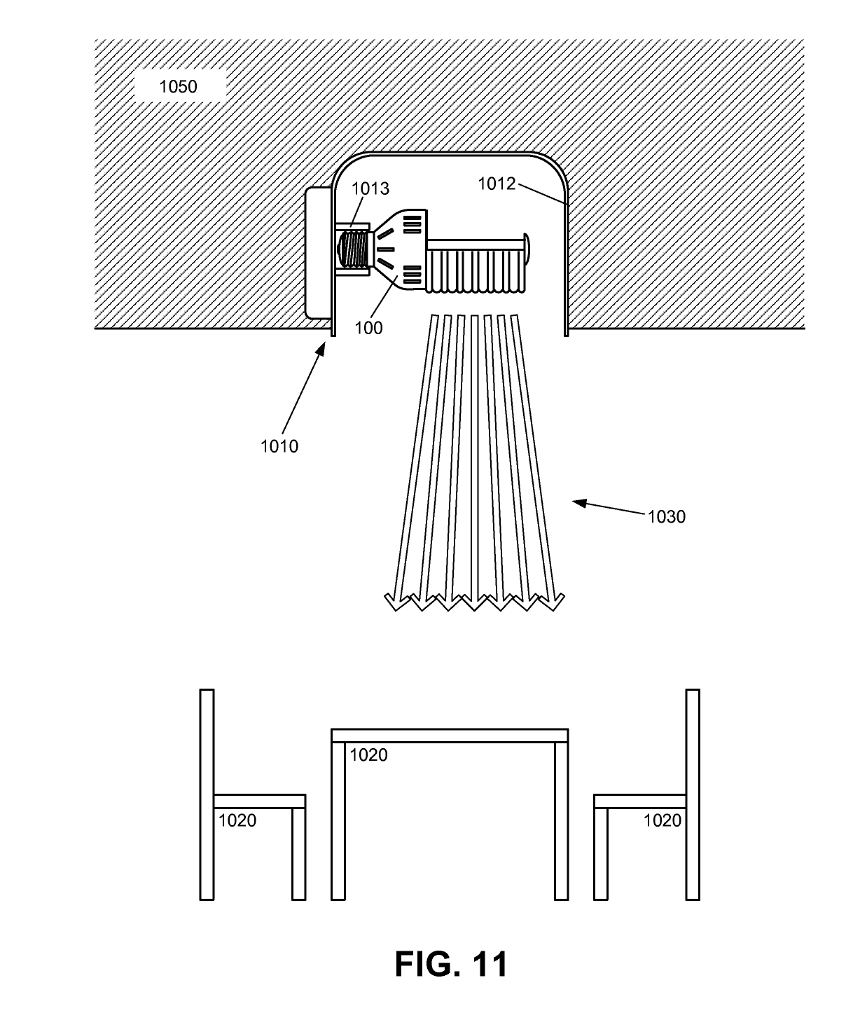

FIG. 11 shows an exemplary application of an LED bulb according to an embodiment of the invention. As shown in FIG. 11, the environment includes a ceiling 1050, a recessed lighting fixture 1010, and objects 1020 in the environment. The light fixture 1010 includes a housing 1012, and an electrical socket 1013. An LED bulb 100 according to an embodiment of the invention is connected to the electrical socket 1013 of the light fixture 1010. Exemplary light rays 1030 illustrating light radiating from the LED bulb 100 illuminate the objects 1020 in the environment. The objects 1020 can be home or office furnishings including desks, couches, and tables.

In such an environment, it can be desirable to illuminate only the objects 1020 and minimize light emanated into other areas of the environment. In this application it is unnecessary to have light emanated up and into the lighting fixture as this light would be wasted. An LED bulb according to an embodiment of the invention can be utilized to efficiently achieve the desired lighting effect. No light is wasted by needlessly illuminating the undesired areas.

The LED bulb 100 in FIG. 11 connects to the light fixture using an Edison style E27 screw-type electrical connector. The LED bulb 100 is installed by screwing the LED bulb 100, into the electrical socket 1013 of the recessed lighting fixture 1010. Generally, Edison-style E27 screw-type electrical connector is not a precision piece of engineering and the socket depth and thread start position will vary between light fixtures. Due to the imprecise nature of the Edison-style E27 screw-type electrical socket and connector, the LED modules of the LED bulb 100 may not be optimally oriented after installation. For example, the LED modules may be facing sideways, or upwards into the light fixture rather than downwards on to the objects 1020. Accordingly, an embodiment of the invention allows the LED modules to be manually rotated to achieve an optimal orientation.

Although the preferred embodiments are disclosed having discrete LED layouts and methods of rotation, embodiments of the invention can include multiple LED layouts and other methods of rotation. It will be apparent to those skilled in the art that other various modifications and variations can be made in embodiments of the invention without departing from the spirit or scope of the invention. Thus, it is intended that embodiments of the invention cover the modifications and variations of this invention provided they come within the scope of the appended claims and their equivalents.

What is claimed is:

1. A light emitting diode bulb, comprising:
a base member having a first surface and a second surface;
an electrical connector at the first surface of the base member;
a plurality of light emitting diode modules stacked on the second surface and along an axis line;
a region defined by two radii extending from the axis and an outer periphery of the plurality of light emitting diodes modules; and
a plurality of side-emitting light emitting diodes on each of the plurality of light emitting diode modules wherein:
the plurality of side-emitting light emitting diodes is within the region.

2. The light emitting diode bulb according to claim 1, wherein the plurality of side-emitting light emitting diodes are oriented such that light is emitted radially with respect to the axis line.

3. The light emitting diode bulb according to claim 1, wherein the plurality of side-emitting light emitting diodes are arranged on a periphery of each of the plurality of light emitting diode modules.

4. The light emitting diode bulb according to claim 1, wherein the plurality of side-emitting light emitting diodes are arranged substantially in an arc that is less than 180 degrees.

5. The light emitting diode bulb according to claim 1, wherein the plurality of light emitting diode modules are stacked about a pillar.

6. The light emitting diode bulb according to claim 5, wherein the pillar is rotatably connected to the second surface of the base member.

7. The light emitting diode bulb according to claim 6, wherein the pillar rotates in a plane that is substantially parallel to the second surface of the base member.

8. The light emitting diode bulb according to claim 5, wherein the plurality of light emitting diode modules are rotatably connected to the pillar.

9. A light emitting diode bulb, comprising:
a base member having a first surface and a second surface;
an electrical connector at the first surface of the base member;
a pillar rotatably connected to the second surface of the base member;
a plurality of light emitting diode modules stacked on the pillar; and
a plurality of side-emitting light emitting diodes on each of the plurality of light emitting diode modules.

10. The light emitting diode bulb according to claim 9, wherein the pillar rotates in a plane that is substantially parallel to the second surface of the base member.

11. The light emitting diode bulb according to claim 9, further comprising:
a region defined by two radii extending from the pillar and an outer periphery of the plurality of light emitting diodes modules wherein the plurality of side-emitting light emitting diodes exist within the region.

12. The light emitting diode bulb according to claim 11, wherein the plurality of side-emitting light emitting diodes are oriented such that light is emitted radially with respect to the pillar.

13. The light emitting diode bulb according to claim 11, wherein the plurality of side-emitting light emitting diodes are arranged on the periphery of each of the plurality of light emitting diode modules.

14. The light emitting diode bulb according to claim 11, wherein the plurality of side-emitting light emitting diodes are arranged substantially in an arc that is less than 180 degrees.

15. A light emitting diode bulb, comprising:
a base member having a first surface and a second surface;
an electrical connector at the first surface of the base member;
a pillar rotatably connected to the second surface of the base member;
a plurality of light emitting diode modules connected to the pillar;
a region defined by two radii extending from the pillar and an outer periphery of the plurality of light emitting diodes; and
a plurality of side-emitting light emitting diodes on each of the plurality of light emitting diode modules wherein:
the plurality of side-emitting light emitting diodes exist in the region.

16. The light emitting diode bulb according to claim 15, wherein the pillar rotates in a plane that is substantially parallel to the second surface of the base member.

17. The light emitting diode bulb according to claim 15, wherein the plurality of side-emitting light emitting diodes are oriented such that light is emitted radially with respect to the pillar.

18. The light emitting diode bulb according to claim 15, wherein the plurality of side-emitting light emitting diodes are arranged on the periphery of each of the plurality of light emitting diode modules.

19. The light emitting diode bulb according to claim 15, wherein the plurality of side-emitting light emitting diodes are arranged substantially in an arc that is less than 180 degrees.
